(19) United States
(12) Patent Application Publication
(10) Pub. No.: US 2005/0255380 A1
(43) Pub. Date: Nov. 17, 2005

(54) Lithium-ion battery seal

(76) Inventors: Brian J. Lasater, Wenatchee, WA (US); Joseph H. Schulman, Santa Clarita, CA (US); Gary D. Schnittgrund, Granada Hills, CA (US)

Correspondence Address: ALFRED E. MANN FOUNDATION FOR;SCIENTIFIC RESEARCH, PO BOX 905, 25134 RYE CANYON LOOP, SUITE 200, SANTA CLARITA, CA, 91380, US

(21) Appl. No.: 11/152,443

(22) Filed: Jun. 13, 2005

Related U.S. Application Data
(63) Continuation-in-part of application No. 10/290,140, filed on Nov. 7, 2002, now abandoned.
(60) Provisional application No. 60/346,031, filed on Nov. 9, 2001.

(51) Int. Cl. H01M 2/08; F16J 15/10

(52) U.S. Cl. 429/184; 277/312; 277/650

(57) ABSTRACT

A hermetic seal that is compatible with lithium-ion electrolyte in lithium batteries is formed in feedthroughs by compression, chemical bonding, and mechanical bonding between the metal pin and a sealing glass, such as Cabal-12. The pin is alternately coated with a metal or a metal oxide to enhance compatibility with the lithium battery environment. The pin surface is deformed to enhance bonding with the glass seal. Mechanical bonds are also achieved by placing the pin/glass seal interface in compression by a compression bushing.

### CROSS REFERENCE TO RELATED APPLICATION

This application is a continuation-in-part of U.S. patent application Ser. No. 10/290,140, filed Nov. 7, 2002; which claims the benefit of U.S. Provisional Application No. 60/346,031, filed Nov. 9, 2001.

### FIELD OF THE INVENTION

The present invention is generally directed to forming glass-to-metal seals that are of particular use when hermeticity is required for very long exposures to harsh environments. These seals can be used for the glass-to-metal seals in components exposed to severe chemical environments, e.g., in headers for ambient temperature lithium-ion batteries.

### BACKGROUND OF THE INVENTION

Hermetic seals are often used for harsh environmental applications. They are used to present a barrier that protects sensitive electronic components from outside environmental conditions, which would otherwise destroy the hardware components. In the case of medical devices, hermetic seals can also protect living tissue from electronic components. The challenge is to manufacture the hermetic seal as ruggedly as possible for applications where hermeticity will be required for extended exposures to harsh environments.

Ambient temperature lithium batteries provide high energy densities and high rate capabilities at low temperatures; however, a major problem associated with these cells is presented by the highly corrosive nature of lithium chemistry. Standard glass insulators, used to separate the header of a battery from the center pin, while providing a hermetic seal for the battery, experience extensive corrosion over relatively short periods of time, thus severely limiting the shelf life of the cells.

An additional problem associated with conventional lithium batteries is encountered when uncoated molybdenum is used as the pin material for center pins in lithium battery headers. Molybdenum pins are subject to rapid corrosion when the polarity is reversed from a negative terminal to a positive and hence are not usable for lithium battery designs. Uncoated molybdenum is difficult to work with, being difficult to weld, difficult to machine as it is very brittle, and is susceptible to aqueous corrosion. It is desirable to use alternative pin materials, instead of uncoated molybdenum. Replacement of uncoated molybdenum with weldable, machinable, and chemically resistant alloys improves both the ability to manufacture lithium batteries and their ultimate performance.

In order to form an acceptable glass-to-metal seal in a lithium battery at ambient temperature the glass must meet three criteria. First, it must have a high resistance to lithium corrosion; second, it must be able to make a hermetic seal between the metal header and the metal center pin, which requires a thermal expansion match between the glass and the pin; and, third, it must be an electrical insulator, so that the header and the center pin are electrically isolated.

Also, where feedthroughs are utilized in connection with implanted devices, where the electrical terminals may come into contact with body fluids, it is necessary to choose terminals or pins made of bio-stable materials since there is the possibility of hydrogen embrittlement occurring, especially at the negative terminal in a lithium-ion battery.

One glass used in the glass-to-metal seal in headers for ambient temperature lithium batteries is TA-23, which has a finite corrosion rate when in contact with lithium metal that limits the lifetime of the battery.

Glasses based on the CaO—Al₂O₃—B₂O₃ and CaO—MgO—Al₂O₃—B₂O₃ systems have been developed to improve the corrosion resistance and extend the battery lifetime. Cabal-12 is a promising glass which exhibits corrosion resistance. Although this glass has desirable corrosion resistance and resistance to cracking, many metals do not wet Cabal-12 so as to create strong, hermetic seals, nor do the metals exhibit weldability or desired thermal expansion characteristics. Like TA-23, Cabal-12 has a CTE that approximates that of the molybdenum pin, which is about 6.0×10⁻⁶/° C. Cabal-12 has superior corrosion resistance over TA-23. The alkaline earth alumino-borate glasses, such as CaO—Al₂O₃—B₂O₃ and CaO—MgO—Al₂O₃—B₂O₃ have a CTE range, on the order of 6.0-9.0×10⁻⁶/° C., making them unsuitable for sealing to high CTE metal pins.

U.S. Pat. No. 5,015,530 describes glass-to-metal seals for use in lithium electrolyte environments, using glass compositions that seal hermetically with higher expansion, metal pin materials. Alkaline earth-aluminoborate glasses, based on the (CaO, SrO, BaO)—B₂O₃—Al₂O₃ systems and high thermal expansion metal pins are discussed. The glasses are boroaluminate glasses with SrO and BaO substituted for the CaO and MgO used in Cabal-12, and a CaO—B₂O₃—Al₂O₃ glass, having CTEs that match the CTE of the pin materials, while resisting attack by lithium. The composition of these glasses is adjusted to achieve a CTE between 9.0 and 12×10⁻⁶/° C., allowing hermetic seals to high CTE pin materials, such as 446 stainless steel (CTE of 11.4×10⁻⁶/° C.) and Alloy-52 (CTE of 9.8×10⁻⁶/° C.).

U.S. Pat. No. 5,821,011 addresses a similar issue for implants of bio-stable materials. The glass insulator is a Cabal-12 glass. The terminal is comprised of a metal that has CTEs compatible with the glass seal. For glass seals having a CTE in the range of 6.8-8.0×10⁻⁶/° C. the terminal is a thin layer of titanium clad over niobium or tantalum. For glass seals having a thermal expansion in the range of 8.0-9.0×10⁻⁶/° C. the terminal is platinum, platinum-iridium, their alloys, or pure titanium.

U.S. Pat. No. 5,851,222 discusses centerless grinding of pins for lithium batteries for implantable medical devices where the pin may be platinum, stainless steel, aluminum, tantalum, niobium, or titanium. TA-23 and Cabal-12 sealing glasses are also discussed.

This conventional sealing scenario is fundamentally flawed in two regards. First, the design of glass-to-metal seals generally requires that the sealing glass 7 have a higher coefficient of thermal expansion (CTE) than the pin 1, FIG. 1. This enables the bonded assembly 10, when cooled from the sealing temperature to room temperature, to have a net compressive stress within the seal. Since glasses are weak in tension, a net tensile stresses can lead to failure of the seal. In the case of the titanium header 5, alkaline earth alumino-borate sealing glass candidates 7 and the platinum pin 1, the platinum has a higher CTE than the Cabal glass and is therefore an improper seal design.

Another shortcoming is based upon the desire for the sealing glass 7 to flow and wet to the platinum pin 1. The alkaline earth alumino-borate sealing glass 7 candidates do not wet certain metals, such as platinum. Since they do not wet platinum or platinum alloys, they do not exhibit chemical bonding.

In a typical lithium-ion bonded assembly 10, titanium, titanium alloy or a lithium-ion resistant metal will form the header 5 (see FIG. 1). Cabal-12 sealing glass 7 is a standard in the industry. Other alkaline earth alumino-borates are known, see for example U.S. Pat. No. 5,104,738. The pin 1 used in the seal is platinum or platinum alloy.

A need exists for an improved lithium-ion battery header.

### SUMMARY OF THE INVENTION

The present invention is directed to the formation of seals that are of particular use when hermeticity must be retained for long exposures to harsh environments.

Lithium-ion batteries, for example, contain a very corrosive electrolyte. A lithium-ion battery in a conventional application may not require true hermeticity because the battery will “wear out” before the seal does. However, the use of these batteries for rechargeable applications demands that the battery remain hermetically sealed and that the battery keep the electrolyte from escaping the battery package for longer terms. Due to the potential for hydrogen embrittlement or chemical attack by the electrolyte, lithium-ion battery seals occasionally require the use of platinum pin materials. Platinum pins in a glass-to-metal seal, normally, are fabricated as a compression seal. When a Cabal glass is used with a platinum pin, it is not a compression seal because the Cabal glass has a lower coefficient of thermal expansion (CTE) than the platinum. This leads to tensile stresses developing at the glass to pin interface that, in turn, lead to leaking seals. The second problem with lithium-ion battery hermetic seals of glass to platinum pins is the lack of any chemical bonding of the glass to the pin. Platinum is known to be chemically inert. It has been demonstrated that it is possible to push on the end of a pin in a sealed assembly and slide the pin out of the seal with little or no damage to the sealing glass.

In other hermetic applications, such as seawater, saline, in vivo and/or implantable devices and the like, a different set of materials may be used to facilitate the hermetic seal. However, the same essential problem remains. First, it is difficult to find good lithium-ion chemically resistant glasses or glass-ceramics that have higher CTE values than platinum or platinum alloys. Second, even though many metallophillic glasses will readily wet most metals, the exception is platinum. Platinum has long been used for glass melting as an inert container or a lining of the ceramic crucible used in the melting of glasses. Platinum prevents the glass from reacting with the crucible walls and the platinum does not react with the glass. Therefore, even though a much wider glass selection is available for seals exposed to seawater, saline, in vivo and/or in vitro type medical devices, the same problem remains of non-wetting of the platinum pin.

Therefore, if platinum is to be successfully used, it must be used in conjunction with a low expansion core in order to for the glass to effectively put the pin in compression and not rely on any chemical bonding. An appropriate example would be platinum coated Molybdenum or Alloy 42.

This invention addresses the problem in several ways. The first method for consideration is to reduce the coefficient of expansion (CTE) of the pin in the seal, yet maintain the electrochemical protection. This is to be done by using platinum, platinum alloy or platinum family metals that are metallurgically bonded with a lower expansion metal at the core of the pin, such that the lower CTE of the core will yield a seal of proper CTE design considerations. The ratio of platinum metal to low expansion core material may vary as desired, provided that the lower expansion member in the core is the dominant member for expansion characteristics. The low expansion core materials can be molybdenum, tungsten, Invar, Kovar, alloy 36, alloy 42 or any material that will yield a lower expansion CTE than the Cabal 12 or any formulation in the Cabal family of glasses. The platinum may be applied to the low expansion pin material by cladding, electroplating, sputtering, evaporation, CVD or modified CVD, PVD or modified PVD, explosion welding or any such method that will form a metallurgically bonded platinum to low expansion metal core.

Another method to be disclosed is to form a chemical bond at the pin to Cabal glass interface. This may be accomplished by coating either the platinum pin surface with metal(s) known to be wettable by Cabal type glass, such as titanium, niobium, chromium and tantalum, alone or in any combination. It is also known in the art that titanium will bond to platinum. Another preferred method is to selectively remove the platinum in the seal area only and coat the low expansion metal, which is then exposed, with a wettable. The coating may be titanium, tantalum, chromium or niobium, alone or in any combination. It may also be sufficient to only remove the platinum in the seal area and not coat the low expansion metal. Another method is to remove or diminish by abrasion, the platinum in the seal area of the pin. Then to further enhance the seal by coating the abraded area with the above-mentioned metals that are wettable by the Cabal type glass. The abrasion strengthens the seal by providing mechanical retention of the glass to the pin. Such seals have a chemical as well as mechanical sealing characteristic. The coatings of Ti, Nb, Cr and Ta, alone or in any combination may be applied by the above-mentioned methods for applying the platinum to the low expansion metals.

The object of this invention therefore, is to disclose methods of making optimum hermetic seals with platinum pins, platinum alloy pins, molybdenum pins, or any other metal pins used in glass-to-metal seals, using a Cabal glass or other suitable glass, glass-ceramic. Titanium, titanium alloy, stainless steel or any suitable header material that is resistant to lithium-ion chemistry, seawater, saline or bodily fluids, may be used for the header of the seal.

The invention will be best understood from the following description when read in conjunction with the accompanying drawings.

### OBJECTS OF THE INVENTION

It is an object of the invention to bond a platinum pin in a glass-to-metal seal for corrosive environments.

It is an object of the invention to achieve a compression bond in a glass-to-metal seal for corrosive environments.

It is an object of the invention to provide a chemical bond in a glass-to-metal seal for corrosive environments.

It is an object of the invention to provide a mechanical bond in a glass-to-metal seal for corrosive environments.

It is an object of the invention to achieve a glass-to-metal seal in a lithium-ion battery.

Other objects, advantages and novel features of the present invention will become apparent from the following detailed description of the invention when considered in conjunction with the accompanying drawing.

### BRIEF DESCRIPTION OF THE DRAWINGS

FIG. 1 is a feedthrough suitable for a lithium-ion battery application as found in the prior art.

FIG. 2 is an improved feedthrough utilizing platinum family metals and a low thermal expansion core.

FIG. 3 is an improved feedthrough with a wettable oxide coating in the sealed area.

FIG. 4 is an improved feedthrough with a chemical bonding layer in the sealed area.

FIG. 5 is an improved feedthrough with mechanical interlocking pin.

FIG. 6 is an improved feedthrough with high expansion bushing.

FIG. 7 is an improved feedthrough with high expansion header.

FIG. 8 is an improved feedthrough with a protective covering on the pin ends.

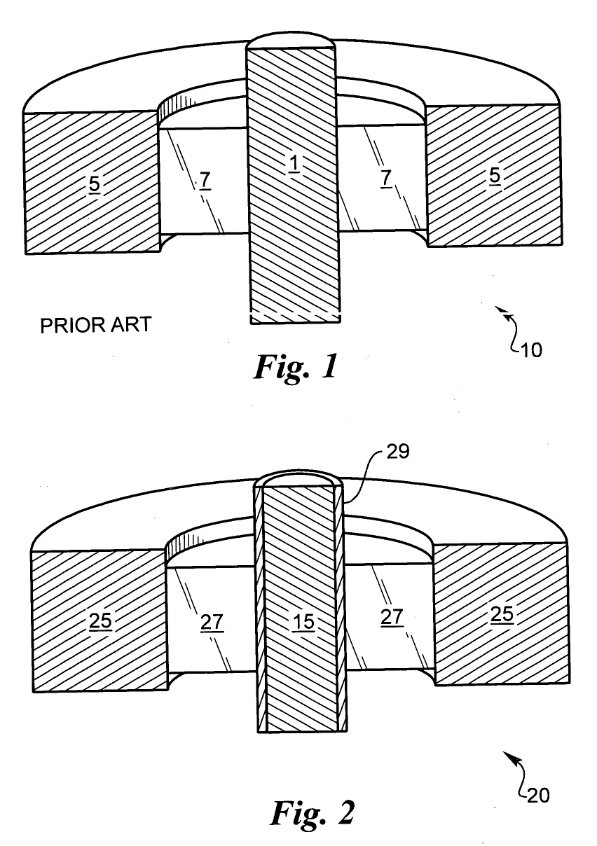

### DETAILED DESCRIPTION OF THE PREFERRED EMBODIMENTS

The following description is of the best mode presently contemplated for carrying out the invention. This description is not to be taken in a limiting sense, but is made merely for the purpose of describing the general principles of the invention. The present invention is directed to improved techniques for generating a hermetic seal that is particularly rugged such that hermeticity can be maintained for extended periods in harsh environments, such as in implantable lithium-ion batteries.

Typical alkaline earth alumino-borates sealing glass compositions are listed in Table 1.

TABLE 1
Alkaline Earth Alumino-Borate Sealing Glass Candidates
and Corrosion Results
After U.S. Pat. No. 5,015,530

| | | Time to |
|---|---|---|
| | | Corrosion |
| Candidate | Formula (mole %) | (days) |
| Babal-1 | 50 BaO—40 B₂O₃—10 Al₂O₃ | >14 |
| Babal-2 | 40 BaO—40 B₂O₃—20 Al₂O₃ | >30 |
| Babal-1C | 30 CaO—20 BaO—40 B₂O₃—Al₂O₃ | 45 |
| Babal-1D | 40 CaO—10 BaO—40 B₂O₃—10 Al₂O₃ | 90 |
| SrBAL-4 | 30 SrO-50 B₂O₃—10 Al₂O₃ | 70 |
| TA-23 | 14.16 CaO—11.49 MgO—3.83 SrO—0.4 | 3-6 |
| | La₂O₃—49.54 SiO₂—12.98 Al₂O₃—7.6 | |
| | B₂O₃ | |
| Cabal-12 | 20 CaO—20 MgO—40 B₂O₃—20 Al₂O₃ | 30-60 |

In the following discussion, reference to alkaline earth alumino-borates sealing glasses, such as Cabal-12, refer to sealing glasses as presented generally in Table 1.

A typical assembly is presented in FIG. 2. The alkaline earth alumino-borate sealing glass 7 candidates will wet titanium, tantalum, aluminum, platinum-aluminide, iridium, rhenium, ruthenium, osmium, palladium, niobium, molybdenum, and their oxides, for example.

As shown in FIG. 2, the CTE of a pin 15 in the bonded assembly 20 is selected to be lower that than of a sealing glass 27, yet the materials are selected to maintain electrochemical protection. Pin coating 29 is selected from platinum, platinum-iridium, iridium, rhenium, rhodium, platinum alloy, or platinum family metals, which are metallurgically bonded to pin 15. The overall thermal dimensional change of the unrestrained coated low-CTE pin 15 must be less than or equal to the dimensional change of the glass 27 surrounding pin 15, thereby placing pin 15 in compression upon cooling.

A lithium-ion resistant metal, such as titanium or a titanium alloy comprises a header 25. Low CTE pin core 15 is comprised of a metal that yields a lower CTE than alkaline earth alumino-borate sealing glass candidates, such as molybdenum, tungsten, Invar, Kovar, Alloy 36, Alloy 42, Alloy 46, or Alloy 52. The coating 29 is applied to the pin core 15 by cladding, electroplating, sputtering, evaporation, CVD, modified CVD, PVD, modified PVD, explosion welding, or a known method that forms a metallurgically-bonded coating 29 to low CTE pin core 15.

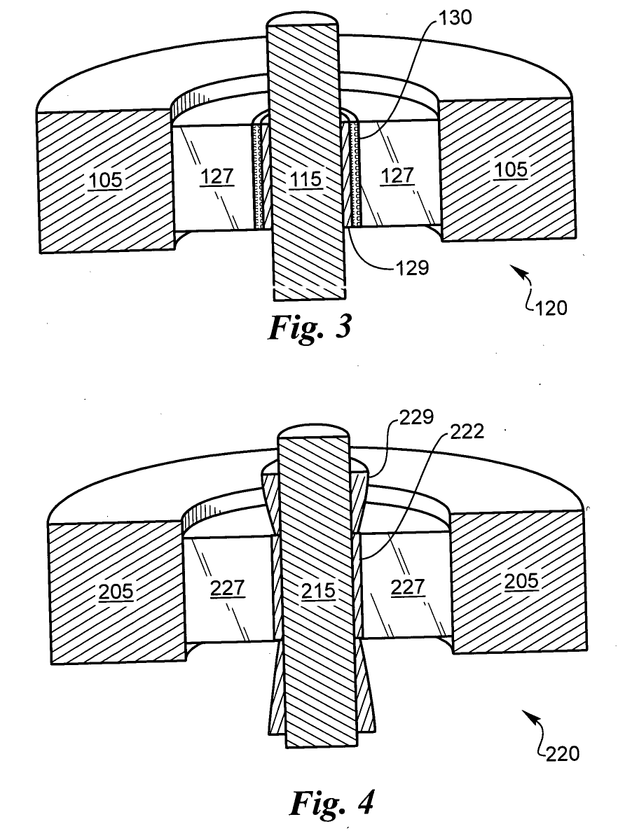

Another embodiment of a bonded assembly 120, presented in FIG. 3, utilizes a chemical bond between a pin 115 to the sealing glass 127. A pin coating 129 is applied to the pin 115, where the pin 115 is preferably platinum, with the pin coating 129 known to be wettable by alkaline earth alumino-borate sealing glass candidates. Known pin coating 129 metals are titanium, aluminum, platinum-aluminide, iridium, rhenium, ruthenium, osmium, palladium, niobium, chromium, and tantalum. They may be applied alone or in combination with each other. A header 105 is identical to that previously described.

An alternative embodiment to form assembly 120 is presented in FIG. 3, where any of the pin coating 129 metals may be used in the oxide form as oxide layer 130 to enhance the chemical bonding to the sealing glass 127. In addition to the above named metals, platinum may be included in its oxide form, since the oxide is wetted by alkaline earth alumino-borate sealing glass candidates. Formation of the oxide coating is accomplished by known methods, such as thermal oxidation of the surface of the pin coating 129 to a metal oxide layer 130 by reactive sputtering or by electrochemical means. Electrochemical means are accomplished by treatment in a solution and applying a voltage.

Another method of achieving a bonded assembly 220 is with a compression bond (see FIG. 4). The pin 215 is comprised of a metal having a lower CTE than glass 227, such as molybdenum, tungsten, Invar, Kovar, Alloy 36, and Alloy 42. Pin 215 is optionally left uncoated or, as illustrated, it is coated with interface coating 222 in the glass 227 to pin 215 interface area. The sealing glass 227 is preferably Cabal-12. The header 205 is comprised of a metal that is known to resist the lithium-ion battery environment, as previously discussed. The low CTE pin 215 is protected from the aggressive environment by coating 229. The coating 229 is selected from a non-wetting metal such as platinum, platinum-iridium, platinum-alloy, or platinum family metals. Coating 222 may be selected from a wetting metal such as titanium, aluminum, platinum-aluminide, iridium, rhenium, ruthenium, osmium, palladium, niobium, chromium, tantalum, or a combination of these metals or their oxides. The pin 215 is preferably bonded in compression by virtue of the CTE differential between the pin 215 and the sealing glass 227. Pin 215 also forms a chemical bond with sealing glass 227 by virtue of coating 222.

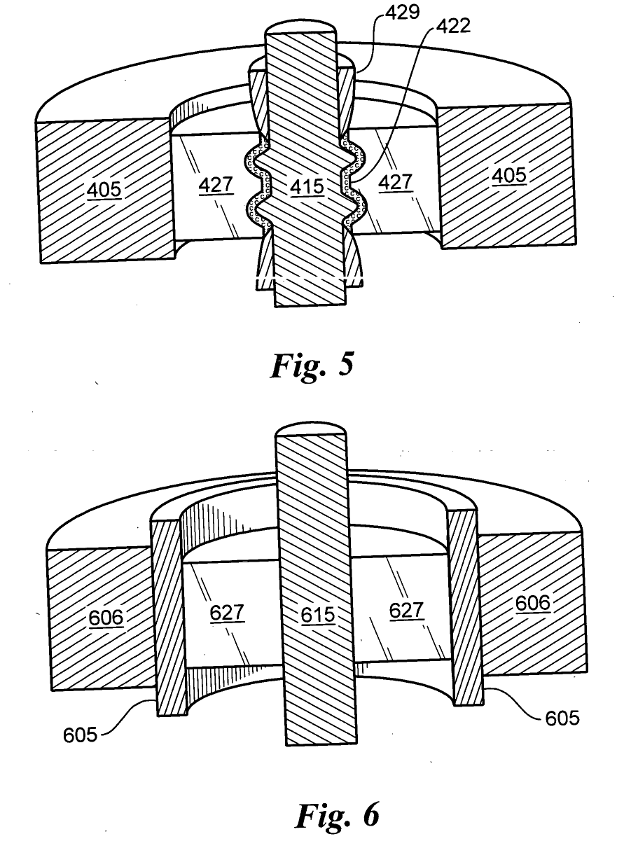

A further alternative embodiment to achieve a competent seal is presented in FIG. 5, where a strong mechanical bond is achieved by deforming the pin 415. The header 405 is made of a known material. Sealing glass 427 is preferably alkaline earth alumino-borate, such as Cabal-12. The mechanical deformation of pin 415 is presented as ridges or deformations that cause the pin 415 to adhere mechanically in sealing glass 427. A further advantage of ridges is that they increase the leakage path length along the interface between pin 415 and sealing glass 427.

The pin 415 may be comprised of a low CTE metal, as previously discussed. A further alternative embodiment is presented in FIG. 5 when a pin coating 429, such as platinum, is applied to the low CTE pin 415. An alternative embodiment is to eliminate the pin coating 429 in the sealing area and to apply a coating 422 of a wettable metal, previously discussed, by conventional means. In this manner, both a strong chemical bond and a strong mechanical bond retain the pin 415 is the sealing glass 427.

A glass-to-metal seal is further improved by increasing the compression within the sea, which is accomplished by adding a high CTE metal bushing 606 to the sealing area of the feedthrough (see FIG. 6). The bushing 606 is comprised of a high CTE metal, preferably a 300-series stainless, such as 316 or 304 stainless, a 400-series stainless, Glidcop™ (a dispersion strengthened copper) (Glidcop is a former registered trademark of SCM Corporation) around a header 605, where the header 605 is comprised of a corrosion resistant metal, such as titanium. A pin 615 may be comprised of either a high CTE metal, such as platinum, or it may be comprised of one of the previously discussed low CTE metals. As the seal is cooled from its bonding temperature, the high CTE 606 bushing shrinks, thereby placing a sealing glass 627 and a pin 615 in compression.

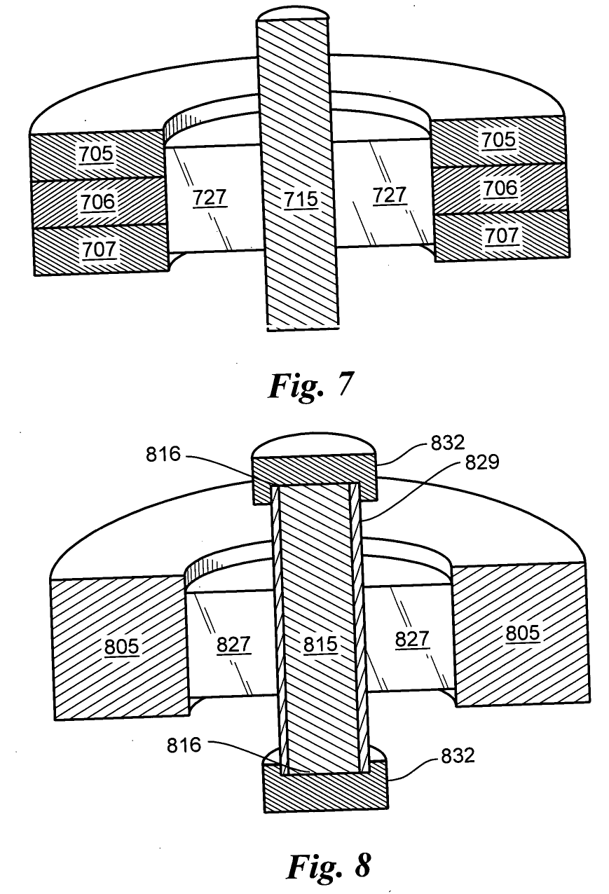

An alternative embodiment of a compression bond is presented in FIG. 7, where the assembly is fabricated using high CTE metals, as discussed for bushing 606. In this embodiment, a layered ring of titanium-stainless-titanium is formed of header 705 on the top and header 707 on the bottom surface surrounding bushing 706, that is preferably comprised of a high CTE metal, thus providing protective upper and lower header surfaces 705 that are exposed to the harsh environment, while the high CTE center bushing 706 provides a compressive force that causes a seal between a pin 715 and a sealing glass 727. It is known that alkaline earth alumino-borate sealing glass candidates wet stainless steel, which enhances the sealing effectiveness at the sealing glass 727 to pin 715 interface. Pin 715 is preferably comprised of a compatible metal, such as platinum, a platinum alloy, or molybdenum.

Another embodiment (see FIG. 8) includes a cap 832 for the end of a pin 815. In a preferred embodiment, titanium, titanium alloy, or a lithium-ion resistant metal comprise header 805. This is required in a harsh chemical environment, such as that encountered in lithium-ion chemistry. If the low CTE metal at the center of the pin 815 is exposed to the chemicals, a corrosion process begins. In this embodiment a “cover” as a cap 832 is placed on the pin 815 at pin end 810. The cap 832 is comprised of platinum or, preferably, the same metal as the pin coating 829 that bonds with the sealing glass 827, as previously discussed. The cap 832 is bonded to the pin end 816 of the pin 815 by laser or resistance welding, for example. The cap 832 may comprise a piece of foil. The end of the pin 815 may also be coated by electroplating a protective metal coating of, for example, platinum or iridium. The pin 832 may be coated by sputtering, evaporation, e-beam deposition, CVD, modified CVD, PVD, and modified PVD.

Accordingly, what has been shown are techniques for forming hermetic seals, suitable for a lithium-ion battery or the like, that are particularly rugged and thus can maintain hermeticity for extended periods in a harsh environment. While the invention has been described by means of specific embodiments and applications thereof, it is understood that numerous modifications and variations could be made thereto by those skilled in the art without departing from the spirit and scope of the invention.

1. A glass-to-metal seal configured for containment within a lithium-ion battery, said seal being compatible with lithium-ion electrolyte, said seal comprising:
a pin having a pin coefficient of thermal expansion;
a glass seal having a glass coefficient of thermal expansion;
said glass coefficient of thermal expansion greater than said pin coefficient of thermal expansion; and
a coating on said pin comprising platinum, iridium, platinum-iridium, or platinum alloy.

2. The glass-to-metal seal according to claim 1, wherein said pin is comprised of molybdenum, tungsten, Invar, Kovar, Alloy 36, or Alloy 42.

3. The glass-to-metal seal according to claim 1, wherein said glass seal is comprised of alkaline earth alumino-borate sealing glass.

4. The glass-to-metal seal according to claim 1, further comprising a titanium header.

5. The glass-to-metal seal according to claim 1, wherein said pin is deformed.

6. The glass-to-metal seal according to claim 1, wherein said coating is oxidized.

7. A glass-to-metal seal configured for containment within a lithium-ion battery, said seal being compatible with lithium-ion electrolyte, said seal comprising:
a pin having a pin coefficient of thermal expansion;
a glass seal having a glass coefficient of thermal expansion;
said glass coefficient of thermal expansion approximately equal to said pin coefficient of thermal expansion; and
a coating on said pin comprised of titanium, aluminum, platinum-aluminide, iridium, rhenium, ruthenium, osmium, palladium, niobium, chromium, tantalum, or their combinations.

8. The glass-to-metal seal according to claim 7, wherein said coating is oxidized.

9. The glass-to-metal seal according to claim 7, wherein said pin is deformed.

10. The glass-to-metal seal according to claim 7, wherein said pin is comprised of platinum.

11. The glass-to-metal seal according to claim 7, wherein said glass seal is comprised of alkaline earth alumino-borate sealing glass.

12. A glass-to-metal seal configured for containment within a lithium-ion battery, said seal being compatible with lithium-ion electrolyte, said seal comprising:
a pin having a pin coefficient of thermal expansion;
a glass seal having a glass coefficient of thermal expansion;
said glass coefficient of thermal expansion greater than said pin coefficient of thermal expansion;
said pin comprised of molybdenum, tungsten, Invar, Kovar, Alloy 36, or Alloy 42;
said glass comprised of alkaline earth alumino-borate sealing glass; and
a coating on said pin.

13. The glass-to-metal seal according to claim 12, wherein said coating is comprised of titanium, aluminum, platinum-aluminide, iridium, rhenium, ruthenium, osmium, palladium, niobium, chromium, tantalum, or their combinations.

14. The glass-to-metal seal according to claim 12, wherein said pin is deformed.

15. The glass-to-metal seal according to claim 12, further comprising a metal header.

16. A glass-to-metal seal configured for containment within a lithium-ion battery, said seal being compatible with lithium-ion electrolyte, said seal comprising:
a pin having a pin coefficient of thermal expansion;
a glass seal having a glass coefficient of thermal expansion;
said glass coefficient of thermal expansion approximately equal to or greater than said pin coefficient of thermal expansion; and
a header comprised of a metal having a CTE that is greater than the glass coefficient of thermal expansion, creating a compressive load on said glass seal.

17. The glass-to-metal seal according to claim 16, wherein
said header is a layered ring;
said header has a top header layer and a bottom header layer;
a bushing between said top and said bottom layers having a coefficient of thermal expansion that is greater than that of said glass seal.

18. The glass-to-metal seal according to claim 17, wherein
said bushing is comprised of stainless steel.

19. The glass-to-metal seal according to claim 17, wherein
said pin is comprised of platinum, platinum alloy, or molybdenum.

20. The glass-to-metal seal according to claim 16, wherein said glass seal is comprised of alkaline earth alumino-borate sealing glass.

21. The glass-to-metal seal according to claim 16, wherein
said header further comprises a bushing that is configured to place said glass seal in compression;
said bushing is comprised of a metal that is selected from the group consisting of a 300-series stainless steel, a 400-serires stainless steel, and a dispersion strengthened copper.

22. The glass-to-metal seal according to claim 21, wherein
said header is comprised of titanium.

23. The glass-to-metal seal according to claim 16, wherein
said bushing has a coefficient of thermal expansion that is greater than said glass coefficient of thermal expansion.

24. A glass-to-metal seal configured for containment within a lithium-ion battery, said seal being compatible with lithium-ion electrolyte, said seal comprising:
a pin having a pin coefficient of thermal expansion and at least one pin end;
a glass seal having a glass coefficient of thermal expansion;
said glass coefficient of thermal expansion greater than said pin coefficient of thermal expansion; and
a cap on said at least one pin end comprised of titanium, aluminum, platinum-aluminide, iridium, rhenium, ruthenium, osmium, palladium, niobium, chromium, tantalum, or a combination of these metals or their oxides.

25. The glass-to-metal seal according to claim 21, wherein said glass seal is comprised of alkaline earth alumino-borate sealing glass.

26. The glass-to-metal seal according to claim 21, wherein said pin is deformed.

27. The glass-to-metal seal according to claim 21, wherein said pin is comprised of molybdenum, tungsten, Invar, Kovar, Alloy 36, or Alloy 42.

28. A method of forming a glass-to-metal seal configured for electrolyte containment within a lithium-ion battery, comprising:
providing a glass seal material having a glass coefficient of thermal expansion and a softening point;
providing a pin that is comprised of a metal having a pin coefficient of thermal expansion;
providing a pin coating metal comprised of platinum, iridium, platinum-iridium, or platinum alloy;
providing said pin metal and said glass seal such that said glass coefficient of thermal expansion is greater than said pin coefficient of thermal expansion;
providing said pin metal that is comprised of molybdenum, tungsten, Invar, Kovar, Alloy 36, or Alloy 42;
providing said glass seal material comprised of alkaline earth alumino-borate sealing glass;
placing a coating of said pin coating material on said pin to form a coated pin;
forming a bonded assembly by placing said coated pin in said glass seal at a temperature above said softening point of said glass seal material; and
cooling said bonded assembly to a temperature below said softening point of said glass seal material.
